(19) United States
(12) Patent Application Publication
(10) Pub. No.: US 2021/0383151 A1
(43) Pub. Date: Dec. 9, 2021

(54) HYPERSPECTRAL DETECTION DEVICE

(71) Applicant: LYSIA, Crepol (FR)

(72) Inventor: Gérald GERMAIN, Crepol (FR)

(73) Assignee: LYSIA, Crepol (FR)

(21) Appl. No.: 17/416,380

(22) PCT Filed: Dec. 18, 2019
(86) PCT No.: PCT/EP2019/085847

§ 371 Date: Jun. 18, 2021

(30) Foreign Application Priority Data
Dec. 19, 2018 (FR) 1873313
Feb. 7, 2019 (FR) 1901202
Jun. 4, 2019 (FR) 1905916

(51) Int. Cl. G06K 9/46; G06K 9/62; G06K 9/00; G06N 20/20; G02B 27/42; G02B 27/46; G01J 3/28

(52) U.S. Cl. CPC G06K 9/46; G06K 9/6277; G06K 9/0063; G06N 20/20; G01J 2003/2826; G02B 27/46; G01J 3/2823; G06K 2009/4657; G06K 2009/00644; G02B 27/4294

(57) ABSTRACT

The invention relates to a device for detecting features in a three-dimensional hyperspectral scene (3), comprising a system for direct detection (1) of features in the hyperspectral scene (3) which incorporates a deep and convolutional neural network (12, 14) designed to detect the one or more searched features in the hyperspectral scene (3) from a compressed image of said hyperspectral scene.

### TECHNICAL FIELD

The present invention relates to a device for detecting objects or features in the focal plane of a scene based on a measurement using a method of compressing the three-dimensional hyperspectral scene into a non-homogeneous image in two dimensions, and a treatment of the obtained image to detect the features sought in the scene.

The invention finds a particularly advantageous application for embedded systems intended to detect objects or features in a scene from their shape, their texture and their luminous reflectance.

The invention can be applied to a large number of technical fields in which hyperspectral detection is sought. In a non-exhaustive manner, the invention can be used, for example, in the medical and dental field, to aid diagnosis. In the plant and mycological field, the invention can also be used to carry out phenotyping, to detect symptoms of stress or disease or to differentiate species. In the field of chemical analysis, the invention can equally be used to measure concentrations. In the field of the fight against counterfeiting, the invention can be used to discern a counterfeit.

### PRIOR ART

For the purposes of the invention, a hyperspectral acquisition detection corresponds to the detection of features in the focal plane of a scene from an acquired two-dimensional image containing a representation of the spatial and spectral information of the focal plane of the scene.

Different methods of compression of the focal plane of a hyperspectral scene are described in the literature. The purpose of these methods is to acquire the focal plane of the hyperspectral scene in a single acquisition without the need to scan the focal plane of the scene in spatial or spectral dimensions.

For example, the thesis “Non-scanning imaging spectrometry”, Descour, Michael Robert, 1994, The University of Arizona, proposes a way to acquire a single two-dimensional image of the observed scene containing all the information for different wavelengths. This method, called CTIS (for “Computed Tomography Imaging Spectrometer”), proposes to capture a diffracted image of the focal plane of the scene observed by means of a diffraction grating disposed upstream of a digital sensor. This diffracted image acquired by the digital sensor takes the form of multiple projections. Each projection makes it possible to represent the focal plane of the observed scene and contains all the spectral information of the focal plane.

Another method, named CASSI (for “Coded Aperture Snapshot Spectral Imaging”), described in the thesis “Compressive spectral imaging”, D. Kittle, 2010, proposes a way of acquiring a single two-dimensional encoded image containing all spatial and spectral information. This method proposes to capture a diffracted image, by means of a diffraction prism, and encoded, by means of an encoding mask, of the focal plane of the observed scene.

These methods, although satisfactory for solving the problem of instantaneous acquisition of the focal plane of the hyperspectral scene, require complex algorithms that are expensive in computing resources in order to estimate the uncompressed hyperspectral scene. The review “Review of snapshot spectral imaging technologies,” Nathan Hagen, Michael W. Kudenov, Optical Engineering 52 (9), September 2013, presents a comparison of hyperspectral acquisition methods and the algorithmic complexities associated with each of them. He Mingyi et al., “Multi-scale 3D deep convolutional neural network for hyperspectral image classification,” 2017 IEEE International Conference on Image Processing, IEEE, Sep. 17, 2017, pp. 3904-3908, Chen Yushi et al., “Deep feature extraction and classification of hyperspectral images based on convolutional neural networks,” IEEE Transactions on Geoscience and Remote Sensing, IEEE Service Center, col. 54, no. 10, Oct. 1, 2016, pp. 6232-6251, and Qiangqiang Yuan et al., “Hyperspectral image denoising employing a spatial-spectral deep residual convolutional neural network”, Cornell University Library, Jun. 1, 2018, are examples of such publications.

Indeed, the CTIS method requires an estimation process based on a two-dimensional matrix representing the transfer function of the diffraction optics. This matrix must be inverted to reconstruct the hyperspectral image. Since the matrix of the transfer function is not completely defined, iterative matrix inversion methods, which are expensive in computing resources, make it possible to approach the result step by step.

The CASSI method and its derivatives also require non-completely defined matrix computations, and use iterative computation methods that are expensive in computing resources in order to approach the result.

In addition, the three-dimensional hyperspectral image reconstructed by these computational methods does not contain additional spatial or spectral information with respect to the two-dimensional compressed image obtained by these acquisition methods.

The estimation by the calculation of the hyperspectral image in three dimensions is therefore not necessary for a direct detection of the features sought in the focal plane of the scene.

Image processing methods for the purpose of detecting features are widely described in the scientific literature. For example, a method based on neural networks is described in “auto-association by multilayer perceptrons and singular value decomposition.” Biological cybernetics, 59 (4): 291-294, 1988. ISSN 0340-1200, H. Bourlard and Y. Kamp. AT.

New methods based on deep and convolutional neural networks are also widely used with results showing very low false detection rates. For example, such a method is described in “Stacked Autoencoders Using Low-Power Accelerated Architectures for Object Recognition in Autonomous Systems,” Neural Processing Letters, Vol. 43, no. 2, pp. 445-458, 2016, J. Maria, J. Amaro, G. Falcao, L. A. Alexander.

These methods are particularly suitable for detecting elements in a color image (generally having 3 channels—Red, Green and Blue) of a scene taking into account the characteristics of shapes, textures and colors of the feature to detect. These methods consider the image homogeneous, and convolutionally process the entire image by the same process.

The processing of the two-dimensional compressed images obtained by the CTIS and CASSI methods can therefore not be performed using a standard deep convolutional neuron network. Indeed, the image obtained by these methods is not homogeneous, and contains nonlinear features in the spectral or spatial dimensions.

The technical problem of the invention consists in directly detecting the features or objects sought from the acquisition of at least one compressed, non-homogeneous, and nonlinear two-dimensional representation containing all the spatial and spectral information of a hyperspectral scene in three dimensions.

### SUMMARY OF THE INVENTION

The present invention proposes to answer this technical problem by directly detecting the desired features by means of a deep and convolutional formal neural network, whose architecture is adapted to direct detection, applied on a compressed two-dimensional image of a three-dimensional hyperspectral scene of the scene.

The three-dimensional hyperspectral image contains no more spatial and spectral information than the compressed image obtained by the CTIS or CASSI acquisition methods since the three-dimensional hyperspectral image is reconstructed from the compressed image. Thus the invention proposes to detect directly in the compressed image the desired features in the focal plane of a scene.

For this purpose, the invention relates to a device for detecting features in a hyperspectral scene.

The invention is characterized in that the device comprises a system for direct detection of features in said hyperspectral scene which integrates a deep convolutional neural network designed to detect the feature(s) sought in said hyperspectral scene from the at least one compressed image of the hyperspectral scene.

In practice, unlike the state-of-the-art of the CTIS method, the invention makes it possible to detect features in said hyperspectral scene in real time between two acquisitions of the hyperspectral focal plane of the observed scene. In doing so, it is no longer necessary to defer the processing of the compressed images and it is no longer necessary to store these compressed images after the detection. Also it is no longer necessary to reconstruct the hyperspectral image in three dimensions before applying the detection method.

In a variant, the compressed image obtained by the optical system contains the focal plane diffracted and encoded according to the coding scheme of a mask introduced into the optical path before diffraction of the scene. Thus, the neural network uses, for the direct detection of the desired features, the following information:
the diagram of the encoding mask used to encode the diffractions of the focal plane of the scene; and
light intensities in the compressed and diffracted image whose coordinates x′ and y′ are dependent on the x and y coordinates of the focal plane of the observed scene.

In practice, contrary to the state of the classical art of the CASSI method, the invention makes it possible to detect features in a hyperspectral scene in real time between two acquisitions of the hyperspectral focal plane of the observed scene. In doing so, it is no longer necessary to defer the processing of the compressed images and it is no longer necessary to store these compressed images after the detection. Also it is no longer necessary to reconstruct the hyperspectral image in three dimensions before applying the detection method.

According to one embodiment, there is provided a device for capturing an image of a hyperspectral scene and detecting features in this three-dimensional hyperspectral scene further comprising a system for acquiring the at least one compressed image of the hyperspectral scene in three dimensions.

According to one embodiment, the acquisition system comprises a compact mechanical embodiment integrable in a portable autonomous device and the detection system is included in said portable and autonomous device.

According to one embodiment, the acquisition system comprises a compact mechanical realization integrable in front of the lens of a camera of a smartphone and the detection system is included in the smartphone.

According to one embodiment, said at least one compressed image is obtained by an infrared sensor of the acquisition system. This embodiment makes it possible to obtain information that is invisible to the human eye.

According to one embodiment, said compressed image is obtained by a sensor of the acquisition system whose wavelength is between 0.001 nanometer and 10 nanometers. This embodiment makes it possible to obtain information on the X-rays present on the observed scene.

According to one embodiment, said compressed image is obtained by a sensor of the acquisition system whose wavelength is between 10,000 nanometers and 20,000 nanometers. This embodiment makes it possible to obtain information on the temperature of the observed scene.

According to one embodiment, said at least one compressed image is obtained by a sensor of the acquisition system whose wavelength is between 300 nanometers and 2000 nanometers. This embodiment makes it possible to obtain information in the domain that is visible and invisible to the human eye.

According to one embodiment, said at least one compressed image is obtained by a sensor of the acquisition system comprising:
a first converging lens configured to focus the information of a scene on an aperture;
a collimator configured to capture the rays passing through said opening and to transmit these rays on a diffraction grating; and
a second convergent lens configured to focus the rays coming from the diffraction grating onto a capture surface.

This embodiment is particularly simple to implement and can be adapted to an existing sensor.

According to one embodiment, said at least one compressed image is obtained by a sensor of the acquisition system comprising:
a first convergent lens configured to focus the information of a scene on a mask;
a collimator configured to capture the rays passing through said mask and to transmit these rays on a prism; and
A second converging lens configured to focus the rays from the prism on a capture surface.

This embodiment is particularly simple to implement and can be adapted to an existing sensor.

For the detection of features from said compressed image, the invention uses a convoluted deep convolutional neural network to calculate a probability of presence of the one or more features sought in said hyperspectral scene. Learning from said deep and convolutional neural network makes it possible to indicate the probability of presence of the features sought for each x and y coordinates of said hyperspectral scene. For example, learning through retro-propagation of the gradient or its derivatives from training data can be used.

According to one embodiment, the neural network is designed to calculate a chemical concentration in said hyperspectral scene from the compressed image.

According to one embodiment, an output of the neural network is scalar or boolean.

According to one embodiment, an output layer of the neural network comprises a layer CONV(u) where u is greater than or equal to 1 and corresponds to the number of desired features.

The convolutional deep neural network for direct detection from the compressed image has an input layer structure adapted for direct detection. The invention has several architectures of the deep layers of said neural network. Among these, a self-encoding architecture as described in the document “SegNet: A Deep Convolutional Encoder-Decoder Architecture for Image Segmentation”, Vijay Badrinarayanan, Alex Kendall and Roberto Cipolla is adapted to indicate the probability of presence of the features sought for each x and y coordinates of the hyperspectral scene.

Said input layer of the neural network is adapted to the structure of the compressed image obtained by the acquisition means. Thus, the input layer is a third order tensor and has two spatial dimensions of size X_{MAX} and Y_{MAX}, and a dimension of depth of size D_{MAX}.

The invention uses the nonlinear relation f(xₜ, yₜ, dₜ)→(x_{img}, y_{img}) defined for xₜϵ[0 . . . X_{MAX}[, yₜϵ[0 . . . Y_{MAX}[ and dₜϵ[0 . . . D_{MAX}[ for calculating the coordinates x_{img} and y_{img} of the pixel of said compressed image whose intensity is copied into the third order tensor of said input layer of the neural network at coordinates (xₜ, yₜ, dₜ).

According to one embodiment, the compressed image contains the diffractions of the hyperspectral scene obtained with diffraction filters. The compressed image obtained contains an image portion of the non-diffracted scene, as well as the projections diffracted along the axes of the different diffraction filters. The input layer of the neural network contains a copy of the chromatic representations of the hyperspectral scene of the compressed image according to the following nonlinear relationship:

$$f ( {x}_{t} , {y}_{t} , {d}_{t} ) = \{ \begin{matrix}{x}_{img} = x + {x}_{offsetX} ( n ) + λ \cdot {λ}_{sliceX} \\ {y}_{img} = y + {y}_{offsetY} ( n ) + λ \cdot {λ}_{sliceY}\end{matrix} \}$$

with:

n=floor (M (dₜ−1)/D_{MAX});
λ=(dₜ−1) mod (D_{MAX}/M);
M the number of diffractions of the compressed image;
dₜ between 1 and D_{MAX}, the depth of the input layer of the neural network;
xₜ between 0 and X_{MAX}, the width of the input layer of the neural network;
yₜ between 0 and Y_{MAX}, the length of the input layer of the neural network;
X_{MAX} the size along the x-axis of the third order tensor of the input layer;
Y_{MAX} the size along the y-axis of the third order tensor of the input layer;
D_{MAX}, the depth of the third order tensor of said input layer;
λ_{sliceX}, the constant of the spectral pitch of the pixel along the x-axis of said compressed image;
λ_{sliceY}, the constant of the spectral pitch of the pixel along the y axis of said compressed image;
x_{offsetX}(n) corresponding to the shift along the x-axis of the diffraction n;
y_{offsetY}(n) corresponding to the shift along the y-axis of the diffraction n.

According to one embodiment, the compressed image contains an encoded two-dimensional representation of the hyperspectral scene obtained with a mask and a prism. The obtained compressed image contains an image portion of the diffracted and encoded scene. The input layer of the neuron network contains a copy of the compressed image according to the following nonlinear relationship: f(xₜ, yₜ, dₜ)={(x_{img}=xₜ); (y_{img}=yₜ)} (Img=MASK if dₜ=0; Img=CASSI if dₜ>0),

with:
dₜ between 0 and D_{MAX};
xₜ between 0 and X_{MAX};
yₜ between 0 and Y_{MAX};
X_{MAX} the size along the x-axis of the third order tensor of the input layer;
Y_{MAX} the size along the y-axis of the third order tensor of the input layer;
D_{MAX}, the depth of the third order tensor of said input layer;
MASK: image of the compression mask used,
CASSI: measured compressed image,
Img: Selected image whose pixel is copied.

These non-linear relationships make it possible to quickly search for the intensity of the pixels of interest in each diffraction. Indeed, some pixels can be neglected if the wavelength of the diffracted image is not significant.

The architecture of the convolutional deep neural network is composed of an encoder making it possible to search for the elementary features specific to the desired detection, followed by a decoder making it possible to generate an image of probabilities of presence of the features to be detected in said compressed image of the hyperspectral focal plane. The encoder/decoder structure makes it possible to search for the elementary and specific features of the main feature sought in said hyperspectral focal plane.

According to one embodiment, the encoder is composed of a succession of convolutional neuron layers alternating with pooling layers (decimation operator of the previous layer) to reduce the spatial dimension.

According to one embodiment, the decoder is composed of a succession of deconvolution neuron layers alternating with unpooling layers (interpolation operation of the previous layer) allowing an increase in the spatial dimension.

For example, such an encoder/decoder structure is described in “SegNet: A Deep Convolutional Encoder-Decoder Architecture for Image Segmentation”, Vijay Badrinarayanan, Alex Kendall, Roberto Cipolla.

According to one embodiment, a set of fully connected neuron layers may be positioned between the encoder and the decoder.

According to one embodiment, the convolutional neural network is designed to detect the one or more features sought in said hyperspectral scene from at least one compressed image and at least one non-diffracted standard image of the hyperspectral scene.

The invention thus makes it possible to correlate the information contained in the different diffractions of the compressed image with information contained in the non-diffracted central part of the image obtained.

The compressed image obtained by the optical system contains the focal plane of the non-diffracted scene at the center, as well as the diffracted projections along the axes of the different diffraction filters. Thus, the neural network uses, for the direct detection of the desired features, the following information of said at least one diffracted image:
the luminous intensity in the central and non-diffracted part of the focal plane of the scene at the x and y coordinates; and
light intensities in each of the diffractions of said compressed image whose coordinates x′ and y′ are dependent on the x and y coordinates of the non-diffracted central part of the focal plane of the scene.

The sets of standard images and compressed images are thus fused by means of said deep and convolutional formal neural network, taking into account the offsets of images taken from the different optical sources, and a direct detection of said desired features is made from information merged using this same deep and convolutional neural network.

For example, such a structure of encoders merging different images of the same focal plane is described in “Multimodal deep learning for robust rgb-d object recognition. In Intelligent Robots and Systems (IROS)”, Eitel, A., Springenberg, J. T., Spinello, L., Riedmiller, M., and Burgard, W. (2015) IEEE/RSJ International Conference on, pages 681 #687. IEEE.

The present invention utilizes different standard and compressed images of the same hyperspectral focal plane. A deep and convolutional neural network image fusion method is presented in “Multimodal deep learning for robust object-recognition rgb-d. In Intelligent Robots and Systems (IROS), Eitel, A., Springenberg, J. T., Spinello, L., Riedmiller, M., and Burgard, W. (2015) IEEE/RSJ International Conference on, pages 681 #687. IEEE. This document presents a deep and convolutional neural network structure using two processing paths, one path per image type of the same scene, completed by layers merging the two paths; the function implemented by this deep and convolutional neural network is a classification of images. This structure as such is not adapted for the present invention because it is not adapted to two-dimensional compressed images of a three-dimensional hyperspectral focal plane, and because its function is the classification of the scene and not the detection of features in this scene.

The different diffractions of the compressed image containing significant spectral information, but each pixel of which contains a sum of the diffractions at different wavelengths, an embodiment of the invention can also use the central part of the image, not diffracted, and allows to search in the complete image the spatial (shape, texture, etc.) and spectral (reflectance) characteristics.

According to one embodiment, the neural network is designed to calculate a probability of presence of the one or more features sought in said hyperspectral scene from the set of said at least one compressed image and said at least one standard not-diffracted image.

According to one embodiment, said convolutional neural network is designed so as to take into account the offsets of the focal planes of the different image acquisition sensors and to integrate the homographic function making it possible to merge the information of the different sensors by taking into account the parallaxes of the different images.

According to one embodiment, there is provided a device for capturing an image of a hyperspectral scene and for detecting features in this three-dimensional hyperspectral scene furthermore comprising a system for acquiring at least one non-diffracted standard image of said hyperspectral scene.

According to one embodiment, said at least one non-diffracted standard image is obtained by an infrared sensor of the acquisition system. This embodiment makes it possible to obtain information that is invisible to the human eye.

According to one embodiment, said at least one non-diffracted standard image is obtained by a sensor whose wavelength is between 300 nanometers and 2000 nanometers. This embodiment makes it possible to obtain information in the domain that is visible and invisible to the human eye.

According to one embodiment, said at least one non-diffracted standard image and said at least one compressed image are obtained by a set of semi-transparent mirrors so as to capture the hyperspectral scene on several sensors simultaneously. This embodiment makes it possible to instantly capture identical planes.

According to one embodiment, the acquisition system comprises means for acquiring at least one compressed image of a focal plane of the hyperspectral scene.

According to one embodiment, the compressed image is non-homogeneous.

According to one embodiment, the compressed image is a two-dimensional image.

According to one embodiment, the neural network is designed to generate an image for each desired feature whose value of each pixel at the coordinates (x; y) corresponds to the probability of presence of said feature at the same coordinates of the hyperspectral scene.

According to one embodiment, the obtained compressed image contains the image portion of the non-diffracted scene in the center.

According to one embodiment, the direct detection system does not implement calculation of a hyperspectal cube of the scene for the detection of features.

According to another aspect, the invention relates to a method for detecting features in a three-dimensional hyperspectral scene, characterized in that a system for direct detection of features in said hyperspectral scene integrating a convolutional neural network detects the one or more features sought in said hyperspectral scene from at least one compressed image of the hyperspectral scene.

According to one embodiment, M=7.

According to another aspect, the invention relates to a computer program comprising instructions which, when the program is executed by a computer, cause it to implement the method.

### SUMMARY DESCRIPTION OF THE FIGURES

The manner of carrying out the invention as well as the advantages which result therefrom will clearly emerge from the following embodiment, given by way of indication but without limitation, in support of the appended figures in which FIGS. 1 to 8 represent:

FIG. 1: a schematic front view of the elements of a capture and detection device in a hyperspectral scene according to an embodiment of the invention;

FIG. 2: a schematic structural representation of the elements of the device of FIG. 1;

FIG. 3: an alternative schematic structural representation of the elements of the device of FIG. 1;

FIG. 4: a schematic representation of the diffractions obtained by the acquisition device of FIG. 2;

FIG. 5: a schematic representation of the architecture of the neural network of FIG. 2.

FIG. 6: a schematic front view of the elements of a capture and detection device in a hyperspectral scene according to a second embodiment of the invention;

FIG. 7: a schematic structural representation of the elements of the device of FIG. 6;

FIG. 8: a schematic representation of the architecture of the neural network of FIG. 7.

### DETAILED DESCRIPTION OF THE INVENTION

By “direct”, when discussing the detection of a feature, it is thus described that the output result of the detection system is the desired feature. We exclude the cases where the output result of the detection system does not correspond to the sought feature, but only corresponds to an intermediate in the calculation of the feature. However, the output result of the direct detection system may, in addition to corresponding to the sought feature, also be used for subsequent processing. In particular, by “direct”, it is meant that the output of the feature detection system is not a hyperspectral cube of the scene which, in itself, does not constitute a feature of the scene.

By “compressed”, we refer to a two-dimensional image of a three-dimensional scene comprising spatial and spectral information of the three-dimensional scene. The spatial and spectral information of the three-dimensional scene is thus projected by means of an optical system on a two-dimensional capture surface. Such a “compressed” image may comprise one or more diffracted images of the three-dimensional scene, or parts thereof. In addition, it may also include a portion of a non-diffracted image of the scene. Thus, the term “compressed” is used because a two-dimensional representation of a three-dimensional spectral information is possible. By “spectral”, we understand that we go beyond, in terms of the number of frequencies detected, a “standard” RGB image of the scene.

By “standard”, as opposed to a “compressed” image, reference is made to a non-diffractive image of the hyperspectral scene. Such an image can still be obtained by optical manipulations through reflecting mirrors or lenses.

By “non-homogeneous”, reference is made to an image whose properties are not identical throughout the image. For example, a “non-homogeneous” image may contain, at certain locations, pixels whose information essentially comprises spectral information at a certain wavelength band, as well as, in other locations, pixels whose information essentially comprises non-spectral information. Computer processing of such a “non-homogeneous” image is not possible because the properties required for its processing are not identical according to the locations in this image.

By “feature”, we refer to a characteristic of the scene—this characteristic can be spatial, spectral, correspond to a shape, a color, a texture, a spectral signature or a combination of these, and can in particular be interpreted semantically.

By “object”, reference is made to the common sense used for this term. An object detection on an image corresponds to the location and to a semantic interpretation of the presence of the object on the imaged scene. An object can be characterized by its shape, color, texture, spectral signature or a combination of these features.

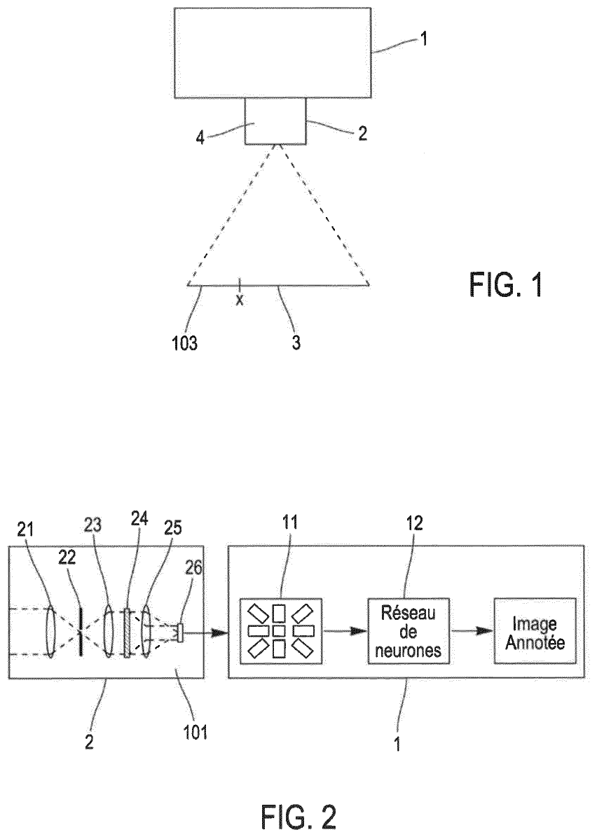

FIG. 1 illustrates a capture device 2 of a hyperspectral scene 3 comprising a sensor, or acquisition system 4, for obtaining a two-dimensional compressed image 11 of a focal plane 103 of an observed scene. The hyperspectral scene can be located in space by means of a non-represented orthonormal frame (x; y; z). To mark the ideas, the x-coordinates are for example measured along the horizontal axis represented in FIG. 1, while the coordinates y are measured along the axis orthogonal to the sheet on which FIG. 1 is represented. The z axis completes the orthonormal frame, and corresponds for example to the optical axis of the capture device 2. However, other orientations are possible.

As illustrated in FIG. 2, the capture device 2 comprises a first convergent lens 21 which focuses the focal plane 103 on an opening 22. A collimator 23 captures the rays passing through the opening 22 and transmits these rays to a diffraction grating 24. A second converging lens focuses these rays from the diffraction grating 24 on a capture surface 26.

The structure of this optical assembly is relatively similar to that described in the scientific publication “Computed tomography imaging spectrometer: experimental calibration and reconstruction results”, published in APPLIED OPTICS, volume 34 (1995) number 22.

This optical structure makes it possible to obtain a compressed image 11, illustrated in FIG. 4, having several diffractions R0-R7 of the focal plane 103 arranged around a non-diffracted image of small size C. In the example of FIG. 4, the compressed image 11 has eight distinct diffractions R0-R7 obtained with two diffraction axes of the diffraction grating 24 arranged as far as possible from each other in a plane normal to the optical axis; that is, substantially orthogonal to each other.

Alternatively, three diffraction axes may be used on the diffraction grating 24 so as to obtain a compressed image 11 with sixteen diffractions. The three diffraction axes can be equally distributed, that is to say separated from each other by an angle of 60°.

Thus, in a general way, the compressed image comprises 2R+1 diffractions if R diffraction gratings are used equidistant, that is to say separated by the same angle from each other.

Capture surfaces 26 or 46 (shown below) may correspond to a CCD sensor (for “charge-coupled device” in the English literature, ie a charge transfer device), a CMOS sensor (for “complementary metal-oxide-semiconductor” in the English literature, a technology for manufacturing electronic components), or any other known sensor. For example, the scientific publication “Practical Spectral Photography”, published in Euro-graphics, volume 31 (2012) number 2, proposes to associate this optical structure with a standard digital camera to sense the diffracted image.

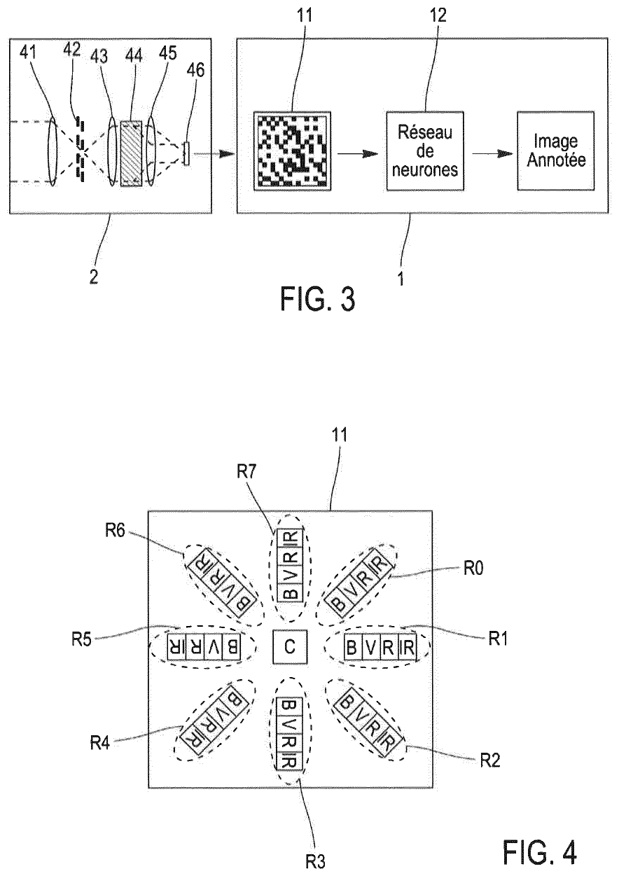

Alternatively, as illustrated in FIG. 3, the capture device 2 may comprise a first convergent lens 41 which focuses the focal plane 103 on a mask 42. A collimator 43 captures the rays passing through the mask 42 and transmits these rays to a prism 44. A second convergent lens 45 focuses these rays from the prism 44 on a capture surface 46. The mask 42 defines a coding for the image 13.

The structure of this optical assembly is relatively similar to that described in the scientific publication “Compressive Coded Aperture Spectral Imaging”, Gonzalo R. Arce, David J. Brady, Lawrence Carin, Henry Arguello, and David S. Kittle.

Alternatively, the capture surfaces 26 or 46 may correspond to the photographic acquisition device of a computer or any other portable device including a photographic acquisition arrangement, by adding the capture device 2 of the hyperspectral scene 3 in front of the photographic acquisition device.

In a variant, the acquisition system 4 may comprise a compact mechanical embodiment integrable in a portable and autonomous device and the detection system is included in said portable and autonomous device.

For example, each pixel of the compressed image 11 is coded on three colors red, green and blue and on 8 bits thus making it possible to represent 256 levels on each color.

Alternatively, the capture surfaces 26 or 46 may be a device whose wavelengths are not captured in the visible part. For example, the device 2 can integrate sensors whose wavelength is between 0.001 nanometer and 10 nanometers or a sensor whose wavelength is between 10,000 nanometers and 20000 nanometers, or a sensor whose length of wave is between 300 nanometers and 2000 nanometers. It can be an infrared device.

When the image 11 of the observed hyperspectral focal plane is obtained, the detection system 1 implements an array of neurons 12 to detect a feature in the scene observed from the information of the compressed image 11.

This neural network 12 aims to determine the probability of presence of the feature sought for each pixel located at the x and y coordinates of the hyperspectral scene 3 observed.

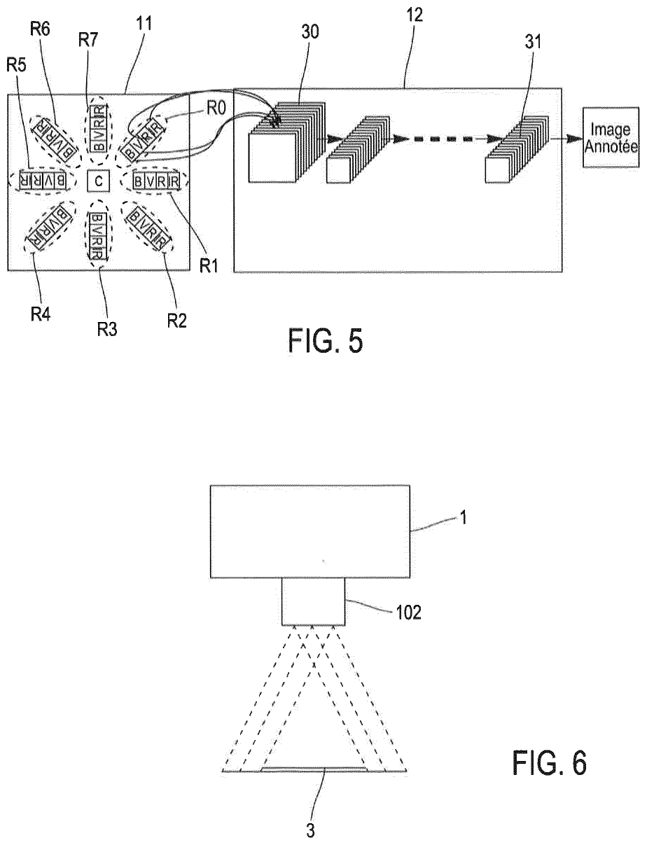

For this purpose, as illustrated in FIG. 5, the neural network 12 comprises an input layer 30, able to extract the information from the image 11 and an output layer 31, able to process this information so as to generate an image whose intensity of each pixel at the x and y coordinates, corresponds to the probability of presence of the feature at the x and y coordinates of the hyperspectral scene 3.

The input layer 30 is populated from the pixels forming the compressed image. Thus, the input layer is a three-order tensor, and has two spatial dimensions of size X_{MAX} and Y_{MAX}, and a size depth dimension D_{MAX}, corresponding to the number of subsets of the compressed image copied into the input layer. The invention uses the nonlinear relation f(xₜ, yₜ, dₜ)→(x_{img}, y_{img}) defined for xₜϵ[0 . . . X_{MAX}[, yₜϵ[0 . . . Y_{MAX}[ and dₜϵ[0 . . . D_{MAX}[ for calculating the coordinates x_{img} and y_{img} of the pixel of the compressed image whose intensity is copied to the third order tensor of said input layer of the neural network at coordinates (xₜ, yₜ, dₜ).

For example, in the case of a compressed image 11 obtained from the capture device of FIG. 2, the input layer 30 can be populated as follows:

$$f ( {x}_{t} , {y}_{t} , {d}_{t} ) = \{ \begin{matrix}{x}_{img} = x + {x}_{offsetX} ( n ) + λ \cdot {λ}_{sliceX} \\ {y}_{img} = y + {y}_{offsetY} ( n ) + λ \cdot {λ}_{sliceY}\end{matrix} \}$$

with:

n=floor (M (dₜ−1)/D_{MAX});
n between 0 and M, the number of diffractions of the compressed image;
λ=(dₜ−1) mod (D_{MAX}/M);
dₜ between 1 and D_{MAX};
xₜ between 0 and X_{MAX};
yₜ between 0 and Y_{MAX};
X_{MAX} the size along the x-axis of the third order tensor of the input layer;
Y_{MAX} the size along the y-axis of the third order tensor of the input layer;
D_{MAX} the depth of the third order tensor of the input layer;
λ_{sliceX}, the spectral pitch constant along the x-axis of said compressed image;
λ_{sliceY}, the spectral pitch constant along the y-axis of said compressed image;
X_{offsetX} (n) corresponding to the offset along the x-axis of the diffraction n;
y_{offsetY} (n) corresponding to the offset along the y-axis of the diffraction n.

Floor is a well known truncation operator.

Mod represents the modulo mathematical operator.

As is particularly clearly seen in FIG. 5, each slice, along the depth dimension, of the third order input tensor of the neural network, receives a part of a diffraction lobe corresponding substantially to a range of wavelengths.

In a variant, the invention makes it possible to correlate the information contained in the different diffractions of the diffracted image with information contained in the non-diffracted central part of the image.

According to this variant, it is possible to add an additional slice in the direction of the depth of the input layer, the neurons of which will be populated with the intensity detected in the pixels of the compressed image corresponding to the non-diffracted detection. For example, if we assign to this slice the coordinate dₜ=0, we can preserve the formula above for the population of the input layer for dₜ greater than or equal to 1, and populate the layer dₜ=0 in the following way:

x_{img}=(Img_{width}/2)−X_{MAX}+xₜ;

y_{img}=(Img_{height}/2)−Y_{MAX}+yₜ;

With:

Img_{width} the size of the compressed image along the x axis;
Img_{height} the size of the compressed image along the y axis.

The compressed image obtained by the optical system contains the focal plane of the non-diffracted scene at the center, as well as the diffracted projections along the axes of the different diffraction filters. Thus, the neural network uses, for the direct detection of the desired features, the following information of said at least one diffracted image:
the luminous intensity in the central and non-diffracted part of the focal plane of the scene at the x and y coordinates; and
light intensities in each of the diffractions of said compressed image whose coordinates x′ and y′ are dependent on the x and y coordinates of the non-diffracted central part of the focal plane of the scene.

Alternatively, in the case of a compressed image 13 obtained from the capture device of FIG. 4, the input layer 30 can be populated as follows:

f(xₜ, yₜ, dₜ)={(x_{img}=xₜ); (y_{img}=yₜ)} (Img=MASK if dₜ=0; Img=CASSI if dₜ>0),

With:

MASK: image of the compression mask used,
CASSI: measured compressed image,
Img: Selected image whose pixel is copied.

On slice 0 of the third order tensor of the input layer the image of the employed compression mask is copied.

On the other slices of the third order tensor of the input layer the compressed image of the hyperspectral scene is copied.

The architecture of said neural network 12, 14 is composed of a set of convolutional layers assembled linearly and alternately with layers of decimation (pooling), or interpolation (unpooling).

A convolutional depth layer, denominated CONV(d), is defined by d convolution kernel, each of these convolution kernel being applied to the volume of the third order input tensor of size yᵢₙₚᵤₜ, dᵢₙₚᵤₜ. The convolutional layer thus generates an output volume, tensor of order three, having a depth d. An ACT activation function is applied to the calculated values of the output volume of this convolutional layer.

The parameters of each convolutional kernel of a convolutional layer are specified by the neural network learning procedure.

Different activation functions ACT can be used. For example, this function can be a ReLu function, defined by the following equation:

ReLu (x)=max (0, x)

In alternation with the convolutional layers, layers of decimation (pooling), or layers of interpolation (unpooling) are inserted.

A decimation layer reduces the width and height of the input of the third-order tensor for each depth of said third order tensor. For example, a decimation layer MaxPool(2,2) selects the maximum value of a tile sliding on the surface of 2×2 values. This operation is applied to all depths of the input tensor and generates an output tensor having the same depth and a width divided by two, and a height divided by two.

An interpolation layer makes it possible to increase the width and height of the input of the third order tensor for each depth of said third order tensor. For example, a MaxUnPool interpolation layer (2.2) copies the input value of a point sliding onto the surface of 2×2 output values. This operation is applied to all depths of the input tensor and generates an output tensor with the same depth and a width multiplied by two, and a height multiplied by two.

A neural network architecture for the direct detection of features in the hyperspectral scene can be as follows:

### Input

[symbol] CONV (64) [symbol]
MaxPool (2,2) [symbol]
CONV (64) [symbol]
MaxPool (2,2) [symbol]
CONV (64) [symbol]
MaxPool (2,2) [symbol]
CONV (64) [symbol]
CONV (64) [symbol]
MaxUnpool (2,2) [symbol]
CONV (64) [symbol]
MaxUnpool (2,2) [symbol]
CONV (64) [symbol]
MaxUnpool (2,2) [symbol]
CONV (1) [symbol]
Output

Alternatively, the number of layers of convolution CONV(d) and decimation MaxPool (2,2) can be modified to facilitate the detection of features having higher semantic complexity. For example, a higher number of convolutional layers makes it possible to process more complex signatures of shape, texture, or spectral characteristics of the feature sought in the hyperspectral scene.

As a variant, the number of layers of deconvolution CONV (d) and interpolation MaxUnpool (2, 2) can be modified in order to facilitate the reconstruction of the output layer. For example, a higher number of deconvolution layers makes it possible to reconstruct an output with greater precision.

Alternatively, convolution layers CONV(64) may have a different depth than 64 in order to process a different number of local features. For example, a depth of 128 allows local processing of 128 different features in a complex hyperspectral scene.

Alternatively, the MaxUnpool interpolation layers (2, 2) may be of different interpolation size. For example, a MaxUnpool layer (4, 4) increases the processing dimension of the upper layer.

As a variant, the activation layers ACT of the ReLu (x) type inserted after each convolution and deconvolution may be of different type. For example, the softplus function defined by the equation: f(x)=log (1+e^{x}) can be used.

Alternatively, the MaxPool decimation layers (2, 2) may be of different decimation size. For example, a MaxPool layer (4, 4) can reduce the spatial dimension more quickly and focus the semantic search of the neural network on local features.

Alternatively, fully connected layers may be inserted between the two central convolutional layers at line 6 of the description to process the detection in a higher mathematical space. For example, three fully connected layers of size 128 can be inserted.

In a variant, the dimensions of the convolutional layer CONV(64), the decimation MaxPool(2, 2) layers and the interpolation MaxUnpool(2, 2) layers can be adjusted on one or more layers, in order to adapt the neural network architecture closest to the type of features sought in the hyperspectral scene.

The weights of said neural network 12 are calculated by means of a training. For example, learning through retro-propagation of the gradient or its derivatives from training data can be used to calculate these weights.

As a variant, the neural network 12 can determine the probability of presence of several distinct features within the same observed scene. In this case, the last convolutional layer will have a depth corresponding to the number of distinct features to be detected. Thus the convolutional layer CONV (1) is replaced by a convolutional layer CONV (u), where u corresponds to the number of distinct features to be detected.

FIG. 6 illustrates a capture device 102 of a hyperspectral scene 3 comprising a set of sensors making it possible to obtain at least one two-dimensional compressed image 11 or 13 and at least one standard image 112 of a hyperspectral focal plane 103 of an observed scene.

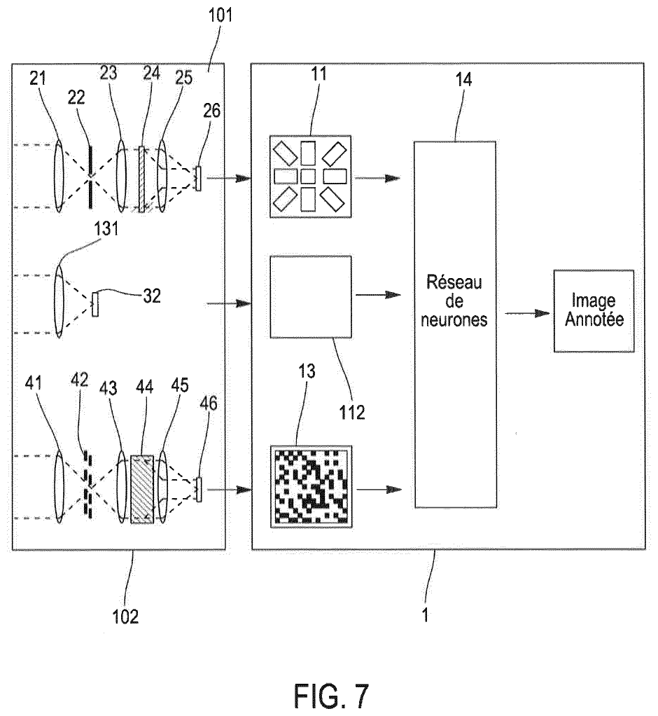

As illustrated in FIG. 7, the capture device 102 comprises at least one acquisition device, or sensor, 101 of a compressed image as described above with reference to FIG. 2.

The capture surface 32 (shown below) may correspond to a CCD sensor (“charge-coupled device” in the English literature, that is to say a charge transfer device), to a CMOS sensor (for “complementary metal-oxide-semiconductor” in the English literature, a technology for manufacturing electronic components), or any other known sensor.

The capture device 102 may further comprise an uncompressed “standard” image acquisition device comprising a converging lens 131 and a capture surface 32. The capture device 102 may further comprise a device for acquiring a compressed image as described above with reference to FIG. 3.

In the presented example, the standard image acquisition device and the compressed image acquisition device are arranged juxtaposed with parallel optical axes, and optical beams overlapping at least partially. Thus, a portion of the hyperspectral scene is imaged by both the acquisition devices. Thus, the focal planes of the different image acquisition sensors are offset relative to each other transversely to the optical axes of these sensors.

Alternatively, a set of partially reflective mirrors is used to capture said at least one non-diffracted standard image 112 and said at least one compressed image 11, 13 of the same hyperspectral scene 3 on multiple sensors simultaneously.

Preferably, each pixel of the standard image 112 is coded on three colors red, green and blue and on 8 bits thus making it possible to represent 256 levels on each color.

Alternatively, the capture surface 32 may be a device whose captured wavelengths are not in the visible part. For example, the device 2 can integrate sensors whose wavelength is between 0.001 nanometer and 10 nanometers or a sensor whose wavelength is between 10,000 nanometers and 20000 nanometers, or a sensor whose length of wave is between 300 nanometers and 2000 nanometers.

When the images 11, 112 or 13 of the observed hyperspectral focal plane are obtained, the detection means implements a neural network 14 to detect a feature in the observed scene from the information of the compressed images 11 and 13, and the standard image 112.

As a variant, only the compressed 11 and standard 112 images are used and processed by the neural network 14.

As a variant, only the compressed 13 and standard 112 images are used and processed by the neural network 14.

Thus, when the description relates to a set of compressed images, it is at least one compressed image.

This neural network 14 aims to determine the probability of presence of the particularity sought for each pixel located at the x and y coordinates of the observed hyperspectral scene 3.

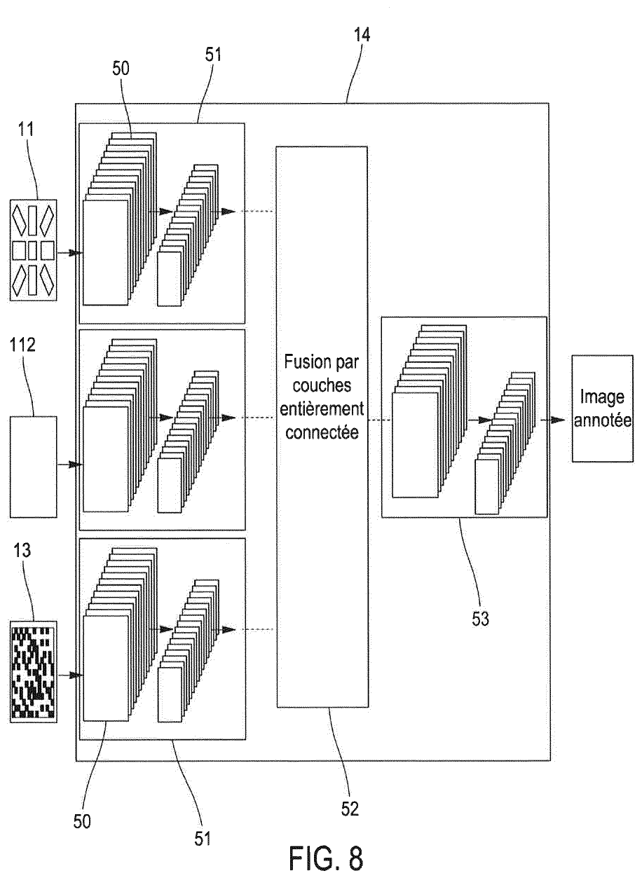

To do this, as illustrated in FIG. 8, the neural network 14 includes an encoder 51 for each compressed image and for each uncompressed image; each encoder 51 has an input layer 50, able to extract the information from the image 11, 112 or 13. The neural network merges the information from the different encoders 51 by means of convolution layers or fully connected layers 52 (case shown in the figure). A decoder 53 and its output layer 131, able to process this information so as to generate an image whose intensity of each pixel, at the x and y coordinates, corresponds to the probability of presence of the feature at the x and y coordinates of the hyperspectral scene 3, is inserted following the fusion of information.

As illustrated in FIG. 5, the input layer 50 of an encoder 51 is filled with the different diffractions of the compressed image 11 as described above.

The above-described filling corresponds to the population of the first input (“Input1”) of the neural network, according to the architecture presented below.

For the second input (“Input2”) of the neural network, the population of the input layer relative to the “standard” image is populated by directly copying the “standard” image into the neural network.

According to an exemplary embodiment where a compressed image 13 is also used, the third input “Input3” of the neural network is populated as described above for the compressed image 13.

A neural network architecture for the direct detection of features in the hyperspectral scene may be as follows:

| Input1 | Input2 | |
|---|---|---|
| Input3 | | |
| [symbol] CONV (64) | [symbol] CONV (64) | [symbol] |
| CONV (64) | | |
| [symbol] MaxPool (2,2) | [symbol] MaxPool (2,2) | [symbol] |
| MaxPool (2,2) | | |
| [symbol] CONV (64) | [symbol] CONV (64) | [symbol] |
| CONV (64) | | |
| [symbol] MaxPool (2,2) | [symbol] MaxPool (2,2) | [symbol] |
| MaxPool (2,2) | | |

```

[symbol]
  CONV (64) [symbol]
  CONV (64) [symbol]
MaxUnpool (2,2) [symbol]
  CONV (64) [symbol]
MaxUnpool (2,2) [symbol]
  CONV (64) [symbol]
MaxUnpool (2,2) [symbol]
  CONV (1) [symbol]
    Output
```

In this description, “Input1” corresponds to the portion of the input layer 50 populated from the compressed image 11. “Input2” corresponds to the portion of the input layer 50 populated from the standard image 112, and “Input3” corresponds to the portion of the input layer 50 populated from the compressed image 13. The line “CONV (64)” at the fifth line of the architecture operates the merger of the information.

In a variant, the line “CONN (64)” at the fifth line of the information merging architecture may be replaced by a fully connected layer having as input all of the MaxPool outputs (2, 2) of the processing paths of all inputs “input1”, “input2” and “input3” and output an tensor of order one serving as input to the next layer “CONN (64)” presented in the sixth line of the architecture.

In particular, the fusion layer of the neural network takes into account the offsets of the focal planes of the different image acquisition sensors, and integrates the homographic function making it possible to merge the information of the different sensors by taking into account the parallaxes of the different images.

The variants presented above for the first embodiment can also be applied here.

The weights of said neural network 14 are calculated by means of a training. For example, learning through retro-propagation of the gradient or its derivatives from training data can be used to calculate these weights.

Alternatively, the neural network 14 can determine the probability of presence of several distinct features within the same observed scene. In this case, the last convolutional layer will have a depth corresponding to the number of distinct features to be detected. Thus the convolutional layer CONV(1) is replaced by a convolutional layer CONV(u), where u corresponds to the number of distinct features to be detected.

According to an alternative embodiment, as shown in FIG. 5, it is not necessary to use a separate dedicated acquisition device to obtain the “standard” image 112. Indeed, as presented above in connection with FIG. 3, in some cases, a portion of the compressed image 11 includes a “standard” image of the hyperspectral scene. These include the image portion C described above. In this case, this image portion “C” of the compressed image 11 can be used as a “standard” input image of the neural network.

Thus, the neural network 14 uses, for the direct detection of the sought features, the information of said at least one compressed image as follows:
the luminous intensity in the central and non-diffracted part of the focal plane of the scene at the x and y coordinates; and
light intensities in each of the diffractions of said compressed image whose coordinates x′ and y′ are dependent on the x and y coordinates of the non-diffracted central part of the focal plane of the scene.

The invention has been presented above in various variants, in which a detected feature of the hyperspectral scene is a two-dimensional image whose value of each pixel at coordinates x and y corresponds to the probability of presence of a feature at the same x and y coordinates of the hyperspectral focal plane of the scene 3. It is possible, however, alternatively, to provide, according to the embodiments of the invention, the detection of other features. According to one example, such another feature can be obtained from the image obtained from the neural network presented above. For this, the neural network 12, 14 may have a subsequent layer, adapted to process the image in question and determine the desired feature. According to an example, this subsequent layer may for example count the pixels of the image in question for which the probability is greater than a certain threshold. The result obtained is then an area (possibly divided by a standard area of the image). According to an example of application, if the image has, in each pixel, a probability of presence of a chemical compound, the result obtained can then correspond to a concentration of the chemical compound in the imaged hyperspectral scene.

According to another example, this later layer may for example have only one neuron whose value (real or Boolean) will indicate the presence or absence of an object or a feature sought in the hyperspectral scene. This neuron will have a maximum value in case of presence of the object or feature and a minimum value in the opposite case. This neuron will be fully connected to the previous layer, and the connection weights will be calculated by means of a learning.

According to a variant, it will be understood that the neural network can also be designed to determine this feature (for example to detect this concentration) without going through the determination of an image of probability of presence of the feature in each pixel.

Detection system 1
capture device 2
hyperspectral scene 3
acquisition system 4
compressed image in two dimensions 11, 13
neural network 12, 14
first convergent lens 21
opening 22
collimator 23
diffraction grating 24
second convergent lens 25
capture surface 26
input layer 30
output layer 31
capture surface 32
first convergent lens 41
mask 42
collimator 43
prism 44
second converging lens 45
capture surface 46
input layer 50
encoder 51
convolution layer or fully connected layer 52
decoder 53
sensor 101
capture device 102
focal plane 103
standard image 112
lens 131

1. Device for detecting features in a hyperspectral scene, in three dimensions,
wherein the device comprises a direct detection system of features in said hyperspectral scene integrating a deep convolutional neural network designed to detect the features sought in said hyperspectral scene from at least one compressed two-dimensional image of the hyperspectral scene.

2. Device according to claim 1, wherein an input layer of the neural network comprises a third-order tensor in which, at the coordinates (xₜ, yₜ, dₜ), the intensity of the pixel of the compressed image of coordinates (x_{img}, y_{img}) is copied, determined according to a nonlinear relation f (xₜ, yₜ, dₜ)→(x_{img}, y_{img}) defined for xₜϵ[0 . . . XMAX [, yₜϵ[0 . . . YMAX [and dₜϵ[0 . . . DMAX[
with
dₜ between 0 and D_{MAX}, the depth of the input layer of the neural network;
xₜ between 0 and X_{MAX}, the width of the input layer of the neural network;
yₜ between 0 and Y_{MAX}, the length of the input layer of the neural network;
X_{MAX} the size along the x-axis of the third order tensor of the input layer;
Y_{MAX} the size along the y-axis of the third order tensor of the input layer;
D_{MAX}, the depth of the third order tensor of said input layer.

3. Device according to claim 1, in which the compressed image contains diffractions of the hyperspectral scene obtained with diffraction filters, in which the obtained compressed image contains an image portion of the non-diffracted scene, as well as diffracted projections along the axes of the different diffraction filters, and in which an input layer of the neural network contains at least one copy of the chromatic representations of said hyperspectral scene of the compressed image according to the following nonlinear relationship:
f(xₜ, yₜ, dₜ)={(x_{img}=x+x_{offsetX} (m)+λ·λ_{sliceX}, y_{img}=y+Y_{offsetY} (m)+λ·λ_{sliceY})}
with:
n=floor (M (dₜ−1)/D_{MAX});
λ=(dₜ−1) mod (D_{MAX}/M);
n, between 0 and M, the number of diffractions of the compressed image;
dₜ between 1 and D_{MAX}, the depth of the input layer of the neural network;
xₜ between 0 and X_{MAX}, the width of the input layer of the neural network;
yₜ between 0 and Y_{MAX}, the length of the input layer of the neural network;
X_{MAX} the size along the x-axis of the third order tensor of the input layer;
Y_{MAX} the size along the y-axis of the third order tensor of the input layer;
D_{MAX}, the depth of the third order tensor of said input layer;
λ_{sliceX}, the constant of the spectral pitch of the pixel along the x-axis of said compressed image;
λ_{sliceY}, the constant of the spectral pitch of the pixel along the y axis of said compressed image;
x_{offsetX} (n) corresponding to the shift along the x-axis of the diffraction n;
y_{offsetY} (n) corresponding to the shift along the y-axis of the diffraction n.

4. Device according to claim 1, wherein the compressed image contains an encoded two-dimensional representation of the hyperspectral scene obtained with a mask and a prism, in which the obtained compressed image contains an image portion of the diffracted and encoded scene, and wherein an input layer of the neural network contains at least one copy of the compressed image according to the following non-linear relationship:
f(xₜ, yₜ, dₜ)={(x_{img}=xₜ); (y_{img}=yₜ)} (Img=MASK if dt=0; Img=CASSI if dt>0),
with:
dₜ between 0 and D_{MAX};
xₜ between 0 and X_{MAX},
yₜ between 0 and Y_{MAX},
X_{MAX} the size along the x-axis of the third order tensor of the input layer;
Y_{MAX} the size along the y-axis of the third order tensor of the input layer;
D_{MAX}, the depth of the third order tensor of said input layer;
MASK: image of the compression mask used,
CASSI: measured compressed image,
Img: Selected image whose pixel is copied.

5. Device according to claim 1, wherein the neural network is designed to calculate a probability of presence of the feature sought in said hyperspectral scene from the at least one compressed image.

6. Device according to claim 1, wherein the neural network is designed to calculate a chemical concentration in said hyperspectral scene from the at least one compressed image.

7. Device according to claim 1, wherein an output of the neural network is scalar or boolean.

8. Device according to claim 1, wherein an output layer of the neural network comprises a layer CONV(u), where u is greater than or equal to 1 and corresponds to the number of desired features.

9. A device for capturing an image of a hyperspectral scene and for detecting features in this three-dimensional hyperspectral scene comprising a device according to claim 1 and further comprising an acquisition system of the at least one compressed image of the hyperspectral scene in three dimensions.

10. Device according to claim 9 wherein the acquisition system comprises a compact mechanical design integrable in a portable and autonomous device, and wherein the detection system is included in said portable and autonomous device.

11. Device according to claim 9, wherein at least one of said compressed images is obtained by an infrared sensor of the acquisition system.

12. Device according to claim 9 wherein the acquisition system comprises a compact mechanical design integrable in front of the lens of a camera of a smartphone and in which the detection system is included in the smartphone.

13. Device according to claim 9, wherein at least one of said compressed images is obtained by a sensor of the acquisition system comprising:
a first converging lens configured to focus the information of a scene on an aperture; and
a collimator configured to capture the rays passing through said opening and to transmit these rays on a diffraction grating; and
a second converging lens configured to focus the rays from the diffraction grating on a pick-up surface.

14. Device according to claim 9, wherein at least one of said compressed images is obtained by a sensor of the acquisition system comprising:
a first converging lens configured to focus the information of a scene on a mask; and
a collimator configured to capture beams passing through said mask and to transmit these rays onto a prism; and
a second converging lens configured to focus rays from the prism onto a pick-up surface.

15. Device according to claim 9, wherein the compressed image is obtained by a sensor of the acquisition system whose wavelength is between 0.001 nanometer and 10 nanometers.

16. Device according to claim 9, wherein the compressed image is obtained by a sensor of the acquisition system whose wavelength is between 10000 nanometers and 20000 nanometers.

17. Device according to claim 9, wherein at least one of said compressed images is obtained by a sensor of the acquisition system whose wavelength is between 300 nanometers and 2000 nanometers.

18. Device according to claim 1, wherein the convolutional neural network is designed to detect the one or more features sought in said hyperspectral scene from said at least one compressed image and at least one non-diffracted standard image of the hyperspectral scene.

19. Device according to claim 18, wherein the neural network is designed to calculate a probability of presence of the one or more features sought in said hyperspectral scene from said at least one compressed image and said at least one non-diffracted standard image.

20. Device according to claim 17, wherein said convolutional neural network is designed to take into account the offsets of the focal planes of the various image acquisition sensors and integrate the homographic function to merge the information of the different sensors taking into account the parallax of the different images.

21. Device for capturing an image of a hyperspectral scene and detecting features in this three-dimensional hyperspectral scene comprising a device according to claim 19, and further comprising an acquisition system of at least one non-diffracted standard image of said hyperspectral scene.

22. Device according to claim 21, wherein at least one of said non-diffracted standard images is obtained by an infrared sensor of the acquisition system.

23. Device according to claim 21, wherein at least one of said non-diffracted standard images is obtained by a sensor whose wavelength is between 300 nanometers and 2000 nanometers of the acquisition system.

24. Device according to claim 21, wherein said at least one non-diffracted standard images and said at least one compressed image are obtained by a set of semi-transparent mirrors so as to capture the hyperspectral scene on several sensors simultaneously.

25. Device according to claim 1 further comprising one and/or the other of the following characteristics:
the acquisition system comprises means for acquiring at least one compressed image of a focal plane of the hyperspectral scene;
the compressed image is non-homogeneous;
the neural network is designed to generate an image for each sought feature where a value for each pixel at the coordinates (x; y) corresponds to the probability of presence of said feature at the same coordinates (x; y) of the hyperspectral scene;
the obtained compressed image contains the image portion of the non-diffracted scene in the center;
the direct detection system does not implement calculation of a hyperspectral cube of the scene for the detection of features;
M=7.

26. A method for detecting features in a three-dimensional hyperspectral scene,
wherein a direct detection system of features in said hyperspectral scene integrating a convolutional neural network, detects the one or more features sought in said hyperspectral scene from at least one compressed two-dimensional image of the hyperspectral scene.

27. A computer program comprising instructions which, when the program is executed by a computer, cause the computer to implement the method of claim 26.
